(19) United States
(12) Patent Application Publication
(10) Pub. No.: US 2008/0184637 A1
(43) Pub. Date: Aug. 7, 2008

(54) Trim assembly

(75) Inventors: David E. Miller, Middlebury, IN (US); Mark Stoops, Elkhart, IN (US)

Correspondence Address: BARNES & THORNBURG LLP, P.O. BOX 2786, CHICAGO, IL, 60690-2786, US

(73) Assignee: Architectural Composite Technologies, LLC

(21) Appl. No.: 11/703,024

(22) Filed: Feb. 6, 2007

(51) Int. Cl. E06B 1/04

(52) U.S. Cl. 52/211

(57) ABSTRACT

A trim assembly for engagement with a frame and a siding comprising a plurality of trim sections engageable with the frame and with the siding. Each trim section engageable with a respective frame member of the frame. Each trim section including a top portion having a frame-engaging side, a central portion disposed beneath the top portion having a frame-engaging side, and a bottom portion disposed beneath the center portion having a frame-engaging side. The frame-engaging side of the central portion disposed laterally farther than the frame-engaging sides of the top and bottom portions and the frame-engaging side of the top portion disposed laterally farther than the frame-engaging side of the bottom portion. The frame-engaging sides of the top and central portions defining a top void configured to receive the upper lip of the respective frame member. The frame-engaging sides of the central and bottom portions defining a bottom void configured to receive the lower lip of the respective frame member. The central portion forming a rib receiveably engageable by the channel of the respective frame member. The trim assembly may also used be used for engagement with a pair of the frames and the siding and include another trim section that includes a pair of the frame-engaging sides.

### FIELD

The present disclosure relates to a trim assembly for a frame for a window, door or other structure.

### BACKGROUND

In the residential and building construction industries, efforts are constantly being made to reduce constructions costs, including costs of materials and the costs of labor. These efforts are typically balanced against other factors, such as, for example, achieving desired aesthetics. The present disclosure relates to window and door trim for use in constructing or remodeling homes, buildings, RV's or the like that may provide advantages in connection with construction costs and also may provide desired aesthetics.

### SUMMARY

In particular, the present disclosure relates to a trim assembly for engagement with a window or door frame and with a siding disposed about the frame. The time assembly comprises a plurality of trim sections configured to engage each other about the frame. Each trim section is engageable with a respective frame member of the frame. Each trim section includes a top portion having a frame-engaging side, a central portion disposed beneath the top portion having a frame-engaging side, and a bottom portion disposed beneath the central portion having a frame-engaging side. The frame-engaging side of the central portion is disposed laterally farther than the frame-engaging sides of the top and bottom portions and the frame-engaging side of the top portion is disposed laterally farther than the frame-engaging side of the bottom portion. The frame-engaging sides of the top and central portions define a top void configured to receive a lip of a respective frame member. The frame-engaging sides of the central and bottom portions define a bottom void configured to receive another lip of the respective frame member. The central portion forms a rib receiveably engageable by the channel of the respective frame member. Each end of each trim section includes a ledge for selective engagement with one of the other trim sections or with the siding. The trim assembly may also used be used for engagement with a pair of the frames disposed in a side-by-side manner and with the siding, and may include an other trim section that instead includes a pair of the frame-engaging sides.

Features and advantages of the disclosure will be set forth in part in the description which follows and the accompanying drawings described below, wherein an embodiment of the disclosure is described and shown, and in part will become apparent upon examination of the following detailed description taken in conjunction with the accompanying drawings.

### BRIEF DESCRIPTION OF THE DRAWINGS

The present disclosure and the advantages thereof will become more apparent upon consideration of the following detailed description when taken in conjunction with the accompanying drawings:

FIG. 1 is a broken perspective view of a trim assembly in accordance with an embodiment of the present disclosure engaged with a window and a siding of a structure;

FIG. 2 is a perspective view of one of the trim sections of the trim assembly of FIG. 1;

FIG. 3 is a partial perspective and exploded view of FIG. 1;

FIG. 4 is a cross section taken along the lines 4-4 of FIG. 1;

FIG. 5 is a perspective view of a trim assembly in accordance with an other embodiment of the present disclosure; and

FIG. 6 is a cross section taken along the lines 6-6 of FIG. 5.

### DETAILED DESCRIPTION

While the present disclosure may be susceptible to embodiment in different forms, there is shown in the drawings, and herein will be described in detail, an embodiment with the understanding that the present description is to be considered an exemplification of the principles of the disclosure and is not intended to limit the disclosure to the details of construction, methods and the arrangements of components set forth in the following description or illustrated in the drawings.

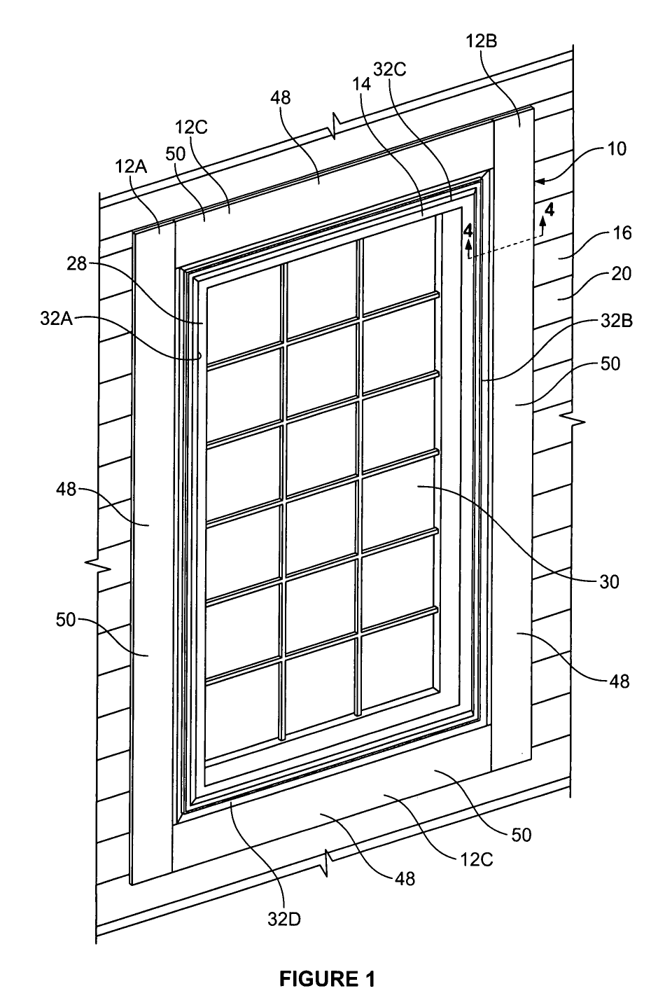

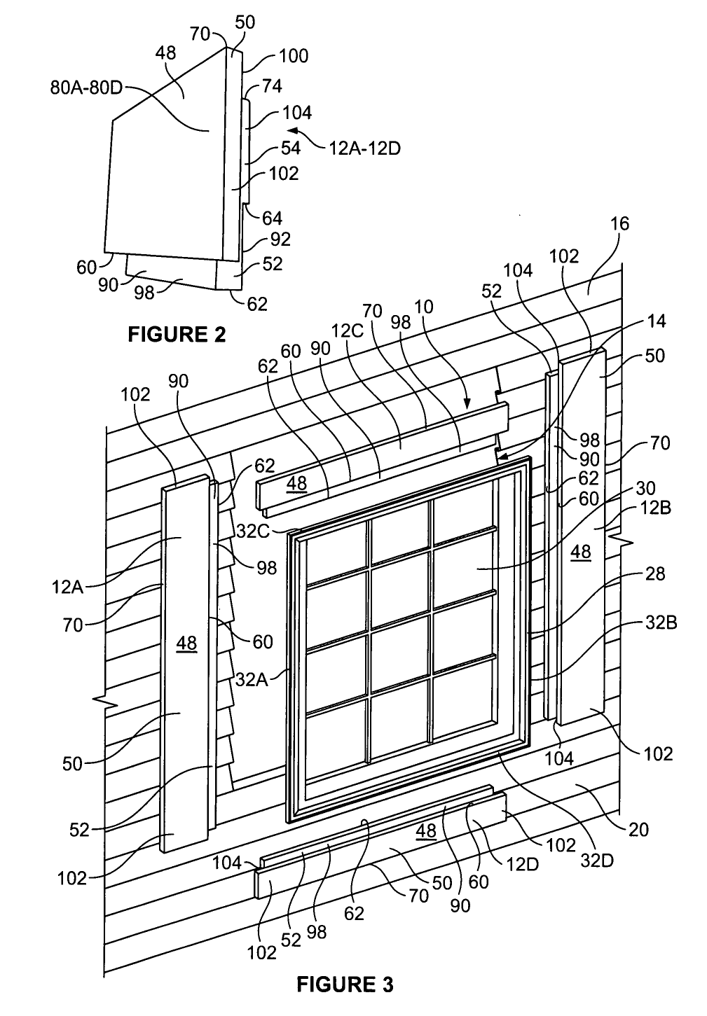

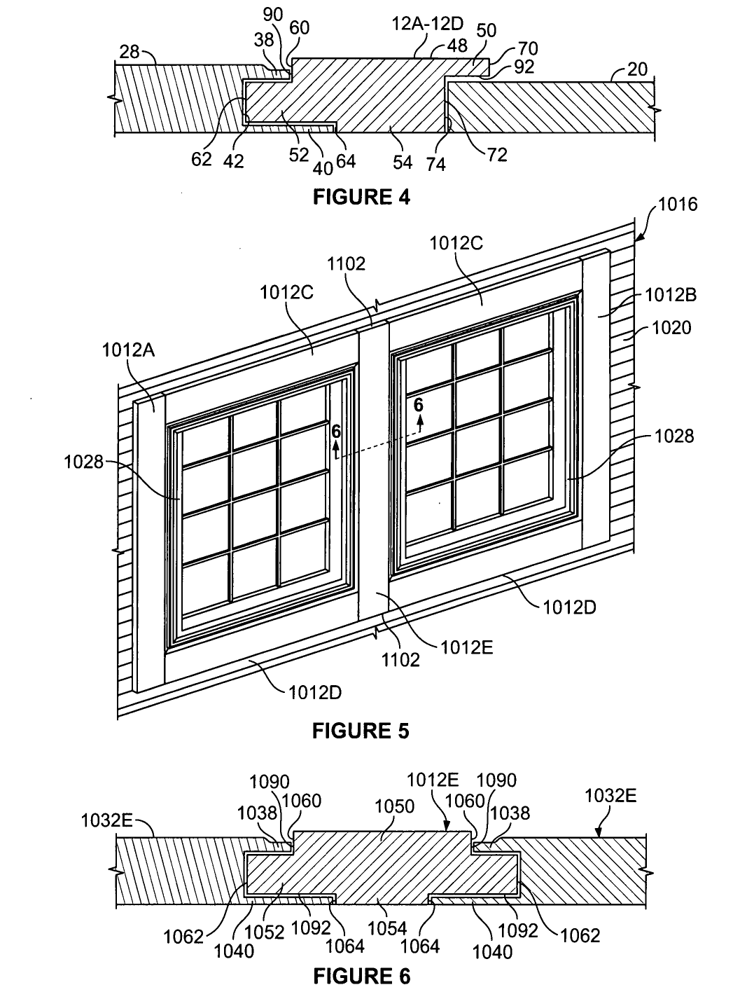

FIGS. 1-4 illustrate a trim assembly 10 in accordance with an embodiment of the present disclosure comprising a plurality of trim sections 12A-12D. The illustrated trim assembly 10 is shown surrounding a window 14 of a structure 16, such as, for example, a house, building, a recreational vehicle or the like. The structure 16 includes siding 20 disposed about the window 14, and the trim sections 12A-12D are interfitted between or otherwise engaged with the window and with the siding 20. The trim sections 12A-12D include the pair of vertically-extending trim sections 12A and 12B and the top and bottom horizontally-extending trim sections 12C and 12D. The trim sections 12A-12D are engaged with each other about the window 14, forming a rectangle.

The illustrated window 14 is a standard commercially-available window comprising a window frame 28 disposed about glass 30. The window frame 28 includes a plurality of frame members 32A-32D, namely, a pair of vertically-extending frame members 32A and 32B and a pair of horizontally-extending frame members 32C and 32D. Each of the frame members 32A-32D has a unitary construction or any other suitable construction, and includes an upper lip 38 and a lower lip 40 extending laterally farther than the upper lip 38. The upper lip 38 and the lower lip 40 define a channel 42 along the entire length of the frame member 32A-32D. The window 14 may be in any suitable form in accordance with other embodiments of the present disclosure. Further, the window frame 28 may instead be a door frame of may be any other suitable frame in accordance with other embodiments of the present disclosure.

Each of the trim sections 12A-12D has a unitary construction and is constructed of a rigid closed cell polyurethane or any other suitable material. Each of the trim sections 12A-12D includes a top surface 48 having a wood trim appearance. Each of the trim sections 12A-12D may have any suitable length, depending upon the dimensions of the window 14. In the embodiment illustrated in FIGS. 1-4, each of the trim sections 12A-12D is identical to each other trim section except that the vertically-extending trim sections 12A and 12B extending along the sides of the window 14 are longer than the top and bottom trim sections 12C and 12D. One side of each of the trim sections 12A-12D engages a respective frame member 32A-32D of the window frame 28. The other side of each of the trim sections 12A-12D engages the siding 20. Further, each of the trim sections 12A-12D includes structure on each end selectively engageable with one of the other trim sections 12A-12D or the siding 20.

In the embodiment illustrated in FIGS. 1-4, each trim section 12A-12D comprises a top portion 50 including the top surface 48, a central portion 52 disposed below the top portion 50, and a bottom portion 54 disposed below the central portion 52. The central portion 52 is thicker than the top portion 52 and the bottom portion 54, and the bottom portion 54 is substantially thinner than the central portion 52 and top portion 50. Each of the top portion 50, central portion 52, and bottom portion 54 includes a frame-engaging side 60, 62 and 64, respectively, for engaging the respective frame member 32A-32D and a siding-engaging side 70, 72 and 74, respectively for engaging the siding 20. Each of the trim sections 12A-12D includes a pair of ends 80A-80D for engaging other trim sections 12A-12D or the siding 20 as described below.

On the frame-engaging side of each trim section 12A-12D, the central portion 52 extends laterally farther than the top and bottom portions 50 and 54, and the top portion 50 extends laterally farther than the bottom portion 54. Thus, the frame-engaging side 62 of the central portion 52 is disposed laterally farther than the frame-engaging sides 60 and 64 of the top portion 50 and the bottom portion 54; and the frame-engaging side 60 of the top portion 50 is disposed laterally farther than the frame-engaging side 64 of the bottom portion 54. The frame engaging sides 60, 62 and 64 thereby define an L-shaped top void 90 to receivingly engage the upper lip 38 of the window frame 28 and an L-shaped bottom void 92 to receivingly engage the lower lip 40 of the window frame 28. The top void 90 is shorter in length and deeper than the bottom void 92. The central portion 52 forms a rib 98 configured to be received by the channel 42 defined by the window frame 28.

On the side-engaging side of each trim section 12A-12D, the top portion 50 extends laterally farther than the central and bottom portions 52 and 54; and the central and bottom portions 52 and 54 extend laterally the same distance. Thus, the side-engaging side 70 of the top portion 50 is disposed laterally farther than the side-engaging sides 72 and 74 of the central and bottom portions 52 and 54 to define an L-shaped channel 100 to receivingly engage the siding 20. The side-engaging sides 62 and 64 of the central and bottom portions 52 and 54 are disposed laterally at the same distance.

Each of the ends 80A-80D of each trim section 12A-12D is configured to selectively engage either one of the other trim sections 12A-12D or the siding 20. In the embodiment of FIGS. 1-4, for example, the ends 80C and 80D of the top and bottom trim sections 12C and 12D engage the vertically-extending trim sections 12A and 12B and the ends 80A and 80B of the vertically-extending trim sections 12A and 12B engage the siding 20.

Accordingly, each end 80A-80D of each trim section 12A-12D includes structure for engaging selectively one of the other trim sections or the siding 20. In the embodiment of FIGS. 1-4, for example, the top portion 50 of each trim section 12A-12D extends longitudinally farther on both ends than the central and bottom portions 52 and 54 forming at each end of each trim sections a ledge 102 and defining at each end of each trim section an end void 104. The central and bottom portions 52 and 54 of each trim section 12A-12D are substantially the same length. The ledges 102 of the top and bottom trim sections 12C-12D are received by the top voids 90 of the vertically-extending trim sections 12A and 12B. The top and bottom trim sections 12C and 12D extend at right angles relative to the vertically-extending trim sections 12A and 12B. The rib 98 of each of the vertically-extending trim sections 12A and 12B is received by one of the end voids 104 of the top trim section 12A and the bottom trim section 12D. Thus, the top voids 90 of each vertically-extending trim section 12A and 12B receives one of the ledges 102 of the top trim section 12C and one of the ledges 102 of the bottom trim section 12D, and also receives substantially along its length and between these two ledges the upper lip 38 of one of the vertically-extending frame members 32A and 32B. Thus, the ledges 102 of the top and bottom trim sections 12C and 12D substantially align with the upper lip 38 of the respective frame member 32A and 32B.

In the embodiment of FIGS. 1-4, the ledges 102 of the vertically-extending trim sections 12C and 12D engage the siding 20, with the siding 20 received by the end void 104 of the vertically-extending trim sections 12C and 12D. Thus, one of the ledges 102 of each of the vertically-extending trim sections 12A and 12B aligns with the top portion 50 of the top trim section 12C and the other ledge 102 of each of the vertically-extending trim sections 12A and 12B aligns with the top portion 50 of the bottom trim section 12D. The siding 20 is received by the voids 104 of trim sections 12A and 12B and channel 100 of each trim section 12C and 12D.

The trim sections 12A-12D of FIGS. 1-4 can instead be oriented such that one or both of the ledges 102 of the top and bottom trim sections 12C and 12B instead engage the siding 20, and one or both of the ledges 102 of the vertically-extending trim sections 12A and 12B instead engage the top and bottom trim sections 12C and 12D. The trim sections 12A-12D can be engaged with each other in any other suitable manner in accordance with other embodiments of the present disclosure.

FIGS. 5-7 illustrate an embodiment of trim assembly 1000 in accordance with an other embodiment of the present disclosure for use in connection with a pair of windows 1014 disposed in a side-by-side manner. The trim assembly 1000 comprises a pair of vertically-extending trim sections 1012A and 1012B along the outside the pair of window frames 1028, two pairs of top and bottom trim sections 1012C and 1012D along the tops and bottoms of both of the window frames 1028, and a central trim section 1012E. The trim sections 1012A-1012D are identical in construction to trim sections 12A-12D described above, but the central trim section 1012E is configured differently than the trim sections 1012A-1012D. In particular, the top portion 1050, central portion 1052 and bottom portion 1054 of central trim section 1012E includes a pair of frame-engaging sides 1060, 1062 and 1064 that are each substantially identical to the frame-engaging sides 60, 62 and 64 of the trim sections 12A-12D described above. Thus, the central trim section 1012E can engage on both sides frame members each of the side-by-side windows 1014. On each side, the side 1062 of the central portion 1052 is disposed laterally farther than the sides 1060 and 1064 of the top and bottom portions 1050 and 1054 to define an L-shaped top void 1090 to receivingly engage the upper lip 1038 of the window frame 1028, and an L-shaped bottom void 1092 to receivingly engage the lower lip 1040 of the window frame 1028. On each side, the side 1060 of top portion 1050 is disposed laterally farther than the side 1064 of the bottom portion 1054. On each side, the top void 1090 is shorter in length and deeper than the bottom void 1092. Further, each end of the central trim section 1012E includes a ledge 1102 and defines an end void 1104 for engaging the siding as shown in FIG. 5, or, in accordance with other embodiments, for engaging one of the trim sections 1012A-1012D.

The present disclosure provides a trim assembly that can be readily assembled on a commercially-available window frame 30 or door frame or any other frame used in construction. The trim assembly in accordance with the present disclosure may be installed directly on the frame without a need to include additional engaging pieces. It also may be readily used to provide a wood trim appearance or other aesthetic appearance.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the disclosure are desired to be protected. The description and figures are intended as illustrations of embodiments of the disclosure, and are not intended to be construed as having or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

The claimed invention is:

1. A trim assembly for engagement with a frame and a siding, the frame having a plurality of frame members, each frame member comprising a body, a upper lip extending distally the body, a lower lip spaced from the upper lip extending distally from the body farther than the upper lip, the top and lower lips defining a channel, the trim assembly comprising:
a plurality of trim sections engageable with the frame and with the siding, each trim section engageable with a respective frame member, each trim section including a top portion having a frame-engaging side, a central portion disposed beneath the top portion having a frame-engaging side, and a bottom portion disposed beneath the center portion having a frame-engaging side, the frame-engaging side of the central portion disposed laterally farther than the frame-engaging sides of the top and bottom portions and the frame-engaging side of the top portion disposed laterally farther than the frame-engaging side of the bottom portion, the frame-engaging sides of the top and central portions defining a top void configured to receive the upper lip of the respective frame member and the frame-engaging sides of the central and bottom portions defining a bottom void configured to receive the lower lip of the respective frame member, the central portion forming a rib receiveably engageable by the channel of the respective frame member.

2. The trim assembly of claim 1 wherein the top portion of each trim section has a siding-engaging side, the central portion of each trim section has a siding-engaging side, and the bottom portion of each trim section has a siding-engaging side, the siding-engaging side of the top portion disposed laterally farther than the siding-engaging sides of the central portion and the bottom portion, the siding-engaging sides of the top, central and bottom portions defining a void for receiveably engaging the siding.

3. The trim assembly of claim 1 wherein each trim section has a pair of ends, each end includes structure configured to selectively engage a respective end of one of the other trim sections or the siding.

4. The trim assembly of claim 3 wherein there are four of the trim sections, the trim sections engageable to form a rectangle.

5. The trim assembly of claim 4 wherein the structure includes a ledge defining an end void at each end of each trim section, each ledge configured to be selectively received by the top void of said other trim section or engage the siding and the end void adapted to selectively receive a rib of the other trim section or the siding.

6. The trim assembly of claim 5 wherein each of the top portion, central portion and bottom portion of each trim section has a length, the length of the top portion of each trim section being greater than the lengths of the central and bottom portions of said trim section to form the ledge at each end of said trim section and define the end void at each end of said trim section.

7. The trim assembly of claim 6 wherein, when the trim sections are engaged to form a rectangle, the ledges of two of the trim sections are received by the top voids of the other two of the trim sections and the ledges of said other two of the trim sections engage the siding.

8. The trim assembly of claim 1 wherein each of the top portion, central portion and bottom portion has a length, the length of the top portion being greater than the lengths of the central and bottom portions to form a ledge and defining an end void.

9. The trim assembly of claim 8 wherein each trim section is configured to engage a pair of other trim sections such that the other trim sections extend at a 90 degree angle relative to said trim section, the ledge of said trim section being receiveable by the top voids of the other trim sections and the rib of the other trim sections being receivable by the end void of said trim section.

10. The trim assembly of claim 9 wherein the ledge of at least one of the trim sections engages the siding, the siding receivable by the end void of said at least one trim section.

11. The trim assembly of claim 1 wherein each of the top portion, central portion and bottom portion of each trim section has a thickness, the thickness of the central portion being greater than the thicknesses of the top and bottom portions.

12. The trim assembly of claim 11 wherein the thickness of the top portion is greater than the thickness of the bottom portion.

13. The trim assembly of claim 1 wherein each trim section is comprised of polyurethane.

14. The trim assembly of claim 1 wherein the top void is deeper than the bottom void.

15. The trim assembly of claim 14 wherein the bottom void is wider than the top void.

16. The trim assembly of claim 1 wherein the bottom void is wider than the top void.

17. A trim assembly for engagement with a pair of frames disposed side by side and a siding, each frame having a plurality of frame members, each frame member comprising a body, a upper lip extending distally the body, a lower lip spaced from the upper lip extending distally from the body farther than the upper lip, the top and lower lips defining a channel, the trim assembly comprising:
a plurality of first trim sections engageable with the frame and with the siding, each first trim section engageable with a respective frame member, each first trim section including a top portion having a frame-engaging side, a central portion disposed beneath the top portion having a frame-engaging side, and a bottom portion disposed beneath the center portion having a frame-engaging side, the frame-engaging side of the central portion disposed laterally farther than the frame-engaging sides of the top and bottom portions and the frame-engaging side of the top portion disposed laterally farther than the frame-engaging side of the bottom portion, the frame-engaging sides of the top and central portions defining a top void configured to receive the upper lip of the respective frame member and the frame-engaging sides of the central and bottom portions defining a bottom void configured to receive the lower lip of the respective frame member, the central portion forming a rib receiveably engageable by the channel of the respective frame member.

18. The trim assembly of claim 17 wherein the top portion of each first trim section has a siding-engaging side, the central portion of each first trim section has a siding-engaging side, and the bottom portion of each first trim section has a siding-engaging side, the siding-engaging side of the top portion disposed laterally farther than the siding-engaging sides of the central portion and the bottom portion, the siding-engaging sides of the top, central and bottom portions defining a void for receiveably engaging the siding.

19. The trim assembly of claim 17 wherein each first trim section has a pair of ends, each end includes structure configured to selectively engage a respective end of one of the other first trim sections or the siding.

20. The trim assembly of claim 17 further comprising a second trim section for engaging both of the frames, the second trim including a top portion having a pair of opposed frame-engaging sides, a central portion disposed beneath the top portion having a pair of frame-engaging sides, and a bottom portion disposed beneath the center portion having a pair of frame-engaging sides, each of the frame-engaging sides of the central portion disposed laterally farther than respective frame-engaging sides of the top and bottom portions and each of the frame-engaging sides of the top portion disposed laterally farther than the respective frame-engaging side of the bottom portion, each of the frame-engaging sides of the top and central portions defining a top void configured to receive the upper lip of a respective frame member or a respective frame and defining a bottom void configured to receive the lower lip of the respective frame member, each central portion forming a rib receiveably engageable by the channel of the respective frame member.

21. The trim assembly of claim 20 wherein each first and second trim section has a pair of ends, each end includes structure configured to selectively engage a respective end of one of the other first trim sections, a respective end of one of the other second trim sections, or the siding.

22. The window finish trim assembly of claim 17 wherein each of the top portions of the first and second trim sections includes a top surface having a wooden appearance.

23. The window finish trim assembly of claim 17 wherein each first and second trim section is comprised of polyurethane.
